(19) United States
(12) Patent Application Publication
(10) Pub. No.: US 2026/0252026 A1
(43) Pub. Date: Aug. 27, 2026

(54) COVER OPENING/CLOSING STRUCTURE AND IMAGE FORMING APPARATUS

(71) Applicant: SHARP KABUSHIKI KAISHA, Osaka (JP)

(72) Inventor: Takumi ARIZONO, Osaka (JP)

(21) Appl. No.: 19/550,628

(22) Filed: Feb. 26, 2026

(30) Foreign Application Priority Data
Feb. 27, 2025 (JP) 2025-030400

(51) Int. Cl. G03G 21/16

(52) U.S. Cl. CPC G03G 21/1633; G03G 21/1619; G03G 2221/1684; G03G 2221/169

(57) ABSTRACT

A cover opening/closing structure comprises: an opening/closing cover member that covers a main body of an apparatus; and a hinge portion that opens and closes the opening/closing cover member about a turning axis line with respect to the main body, wherein the opening/closing cover member includes a grip portion for lifting up the apparatus, and the hinge portion includes: a first hinge portion that turns the opening/closing cover member about a turning axis line on both sides of the grip portion in a turning axis line direction along the turning axis line with respect to the main body; and a second hinge portion that turns the opening/closing cover member about the turning axis line by the grip portion with respect to the main body.

### CROSS-REFERENCE TO RELATED APPLICATION

The present application claims priority from Japanese Application JP2025-030400, the content to which is hereby incorporated by reference into this application.

### BACKGROUND OF THE INVENTION

### Field of the Invention

The disclosure relates to a cover opening/closing structure and an image forming apparatus such as a copier, a multifunctional apparatus, a printer, and a facsimile machine apparatus.

### BACKGROUND ART

### Description of the Related Art

A cover opening/closing structure provided to an apparatus (image forming apparatus) includes an opening/closing cover member that covers a main body of the apparatus and a hinge portion that opens and closes the opening/closing cover member about a turning axis line with respect to the main body.

In such a cover opening/closing structure, the opening/closing cover member may include a grip portion for lifting up the apparatus. In such a case, when an operator grips the grip portion and lifts up the apparatus, it is difficult to stabilize the grip. With this, the gripping stability of the grip portion is degraded.

### SUMMARY OF THE INVENTION

In this regard, a configuration has been described in which a housing includes a handle (grip), the handle includes an end surface that is exposed outward from an exterior cover (opening/closing cover member), and an upper surface that extends inward of the apparatus at an angle from the end surface, the exterior cover has, on an exterior surface thereof, a hole shape surrounding the end surface, and an edge portion of the hole shape has a facing region that faces the upper surface.

However, in the configuration described above, an opening (hole shape) for allowing an operator to grip the handle in the exterior cover communicates with an internal space. Thus, inconveniences caused by the opening communicating with the internal space arise (for example, inconveniences such as dust entering from the outside, or, when the apparatus is an image forming apparatus, waste toner falling onto a floor through the opening).

In view of this, an object of the present disclosure is to provide a cover opening/closing structure and an image forming apparatus including the cover opening/closing structure, which can improve gripping stability of a grip portion when an operator grips the grip portion and lifts up the apparatus, without providing an opening in an opening/closing cover member for allowing an operator to grip the grip portion.

### Solution to Problem

In order to solve the above-mentioned problem, a cover opening/closing structure according to the present disclosure includes an opening/closing cover member that covers a main body of an apparatus, and a hinge portion that opens and closes the opening/closing cover member about a turning axis line with respect to the main body, wherein the opening/closing cover member includes a grip portion for lifting up the apparatus, and the hinge portion includes a first hinge portion that turns the opening/closing cover member about a turning axis line on both sides of the grip portion in a turning axis line direction along the turning axis line with respect to the main body, and a second hinge portion that turns the opening/closing cover member about the turning axis line by the grip portion with respect to the main body.

Further, an image forming apparatus according to the disclosure includes the cover opening/closing structure according to the present disclosure.

### Advantageous Effects of Disclosure

According to the present disclosure, gripping stability of a grip portion when an operator grips the grip portion and lifts up the apparatus can be improved without providing an opening in an opening/closing cover member for allowing an operator to grip the grip portion.

### BRIEF DESCRIPTION OF THE DRAWINGS

FIG. 1 is a perspective view illustrating an external appearance of an image forming apparatus, which is an example of an apparatus, according to an embodiment of the disclosure.

FIG. 2 is a perspective view of a cover opening/closing structure in which an opening/closing cover member is fully opened in the image forming apparatus illustrated in FIG. 1, as viewed from obliquely above from the front side.

FIG. 3 is a perspective view of the cover opening/closing structure in which the opening/closing cover member is fully opened in the image forming apparatus illustrated in FIG. 1, as viewed from obliquely above from the rear side.

FIG. 4 is a perspective view of a state in which one cover-side first hinge portion of a pair of cover-side first hinge portions and the one cover-side second hinge portion of a pair of cover-side second hinge portions are separated away from one main body-side first hinge portion of a pair of main body-side first hinge portions and one main body-side second hinge portion of a pair of main body-side second hinge portions, as viewed from obliquely above from the front side.

FIG. 5 is a perspective view of a state in which the other cover-side first hinge portion of the pair of cover-side first hinge portions and the other cover-side second hinge portion of the pair of cover-side second hinge portions are separated away from the other main body-side first hinge portion of the pair of main body-side first hinge portions and the other main body-side second hinge portion of the pair of main body-side second hinge portions, as viewed from obliquely above from the front side.

FIG. 6 is a perspective view of the state illustrated in FIG. 4, as viewed from obliquely above from the rear side.

FIG. 7 is a perspective view of the state illustrated in FIG. 5, as viewed from obliquely above from the rear side.

FIG. 8 is a perspective view of a state in which the one cover-side first hinge portion and the one cover-side second hinge portion are located at arrangement positions before being engaged with the one main body-side first hinge portion and the one main body-side second hinge portion, respectively, as viewed from obliquely above from the front side.

FIG. 9 is a perspective view of a state after the other cover-side second hinge portion is engaged with the other main body-side second hinge portion and a state in which the other cover-side first hinge portion is located at an arrangement position before being engaged with the other main body-side first hinge portion, as viewed from obliquely above from the front side.

FIG. 10 is a perspective view of the state illustrated in FIG. 8, as viewed from obliquely above from the rear side.

FIG. 11 is a perspective view of the state illustrated in FIG. 9, as viewed from obliquely above from the rear side.

FIG. 12 is a cross-sectional view of a state before engagement of the other main body-side second hinge portion with the other cover-side second hinge portion, as viewed from the rear side.

FIG. 13 is a cross-sectional view of a state after engagement of the other main body-side second hinge portion with the other cover-side second hinge portion, as viewed from the rear side.

FIG. 14 is a perspective view of a state after the one cover-side first hinge portion and the one cover-side second hinge portion are engaged with the one main body-side first hinge portion and the one main body-side second hinge portion, respectively, as viewed from obliquely above from the front side.

FIG. 15 is a perspective view of a state after the other cover-side first hinge portion is engaged with the other main body-side first hinge portion, as viewed from obliquely above from the front side.

FIG. 16 is a perspective view of the state illustrated in FIG. 14, as viewed from obliquely above from the rear side.

FIG. 17 is a perspective view of the state illustrated in FIG. 15, as viewed from obliquely above from the rear side.

FIG. 18 is a perspective view of a cross section of a part corresponding to the other main body-side second hinge portion and the other cover-side second hinge portion in a state in which the opening/closing cover member is closed, as viewed from the rear side.

FIG. 19 is a perspective view illustrating a regulating member that is attached to an image forming apparatus main body in the state illustrated in FIG. 17.

### DETAILED DESCRIPTION OF THE INVENTION

Embodiments according to the disclosure will be described below with reference to the drawings. In the following description, the same components are denoted by the same reference numerals. Their names and functions are also the same. Accordingly, detailed descriptions thereof are not repeated.

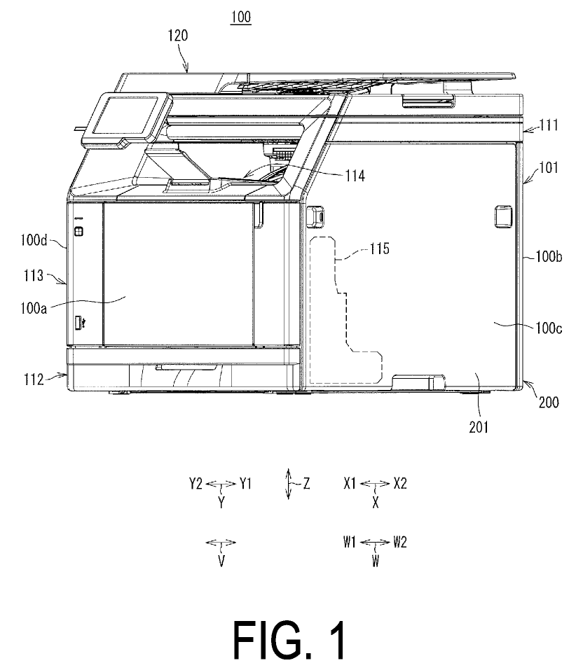

FIG. 1 is a perspective view illustrating an external appearance of an image forming apparatus 100, which is an example of an apparatus, according to an embodiment of the disclosure. The following description is given based on designations in the drawings in which a front-rear direction is denoted as X, a front side is denoted as X1, a rear side is denoted as X2, a direction orthogonal to the front-rear direction X is denoted as a left-right direction Y, a right side is denoted as Y1, a left side is denoted as Y2, and an up-down direction orthogonal to the front-rear direction X and the left-right direction Y is denoted as Z.

A surface of the image forming apparatus 100 on the front side X1 in the front-rear direction X is a front surface 100a (operation surface), and a surface on the rear side X2 in the front-rear direction X as viewed from the front surface 100a is a rear surface 100b. In the left-right direction Y as viewed from the front surface 100a of the image forming apparatus 100, a surface on the right side Y1 is the right side surface 100c, and a surface on the left side Y2 is the left side surface 100d.

The image forming apparatus 100 is a multifunctional apparatus having a copy function, a scanner function, a facsimile machine function, and a printer function. The image forming apparatus 100 includes an image forming apparatus main body 101 and a document forwarding device 120. The image forming apparatus main body 101 includes an image reading device 111, a sheet feeding device 112, an image former 113, and a discharger 114.

The image reading device 111 reads an image on a document, and includes a document reader (scanner), which is omitted in illustration. The image reading device 111 reads an image on a document by the document reader while conveying the document by the document forwarding device 120, or scans and reads a document, which is placed on a document placement table, by the document reader.

In the image forming apparatus 100, when the document forwarding device 120 is opened by a hinge portion (omitted in illustration), the document placement table is exposed, and a document is manually placed on the document placement table.

The sheet feeding device 112 accommodates a sheet such as a recording sheet, and supplies the accommodated sheet to the image former 113. The image former 113 forms (prints) an image onto the sheet fed by the sheet feeding device 112, based on image data. The discharger 114 discharges the sheet subjected to image formation by the image former 113.

Further, the image forming apparatus 100 includes a powder collection container 115. The powder collection container 115 accommodates waste toner discharged from the image forming apparatus main body 101. The powder collection container 115 is attached to the image forming apparatus main body 101 from any side in the left-right direction Y (in this example, from the right side Y1). In detail, in the image forming apparatus main body 101, the powder collection container 115 is provided on one side in the left-right direction Y (in this example, the right side Y1). Specifically, the powder collection container 115 is removed from the image forming apparatus main body 101 from the one side (Y1) in the left-right direction Y, and is mounted thereto from the one side (Y1) to the other side (Y2) in the left-right direction Y to be attached to the right side surface 100c of the image forming apparatus main body 101.

### Present Embodiment

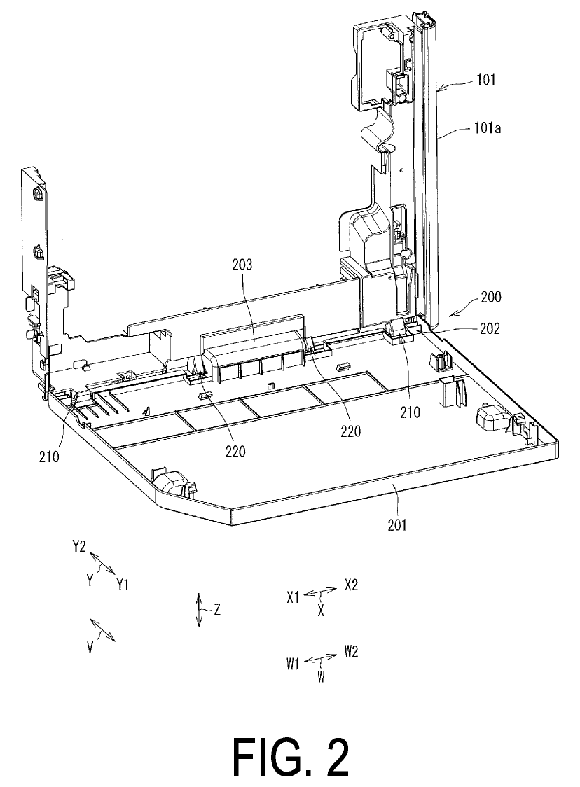

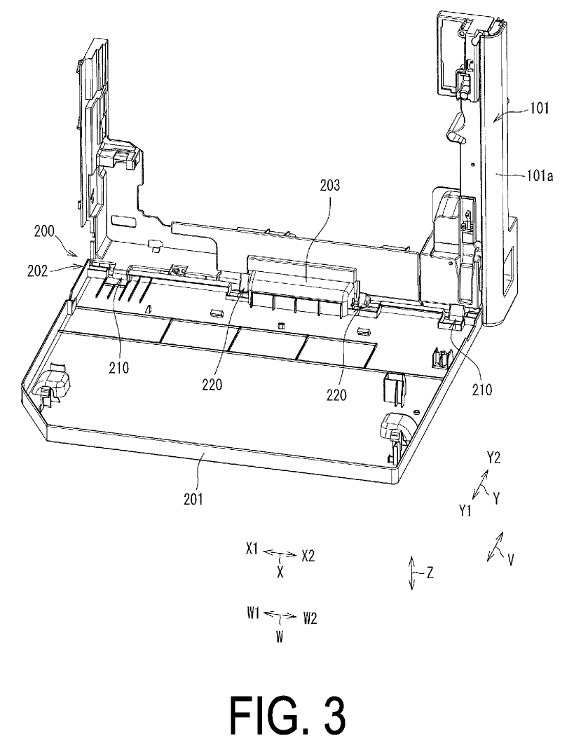

FIGS. 2 and FIG. 3 are perspective views of a cover opening/closing structure 200 in which an opening/closing cover member 201 is fully opened in the image forming apparatus 100 illustrated in FIG. 1, as viewed from obliquely above from the front side X1 and the rear side X2, respectively.

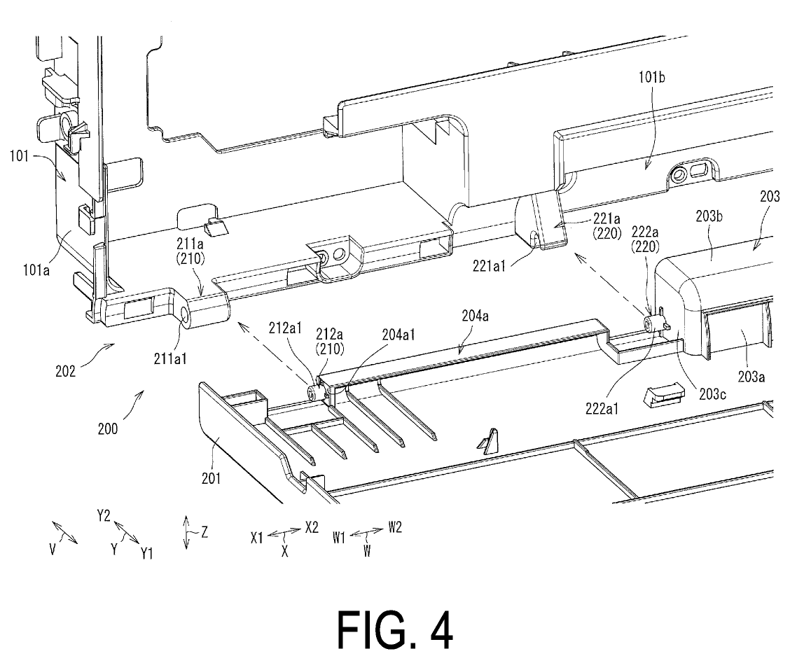

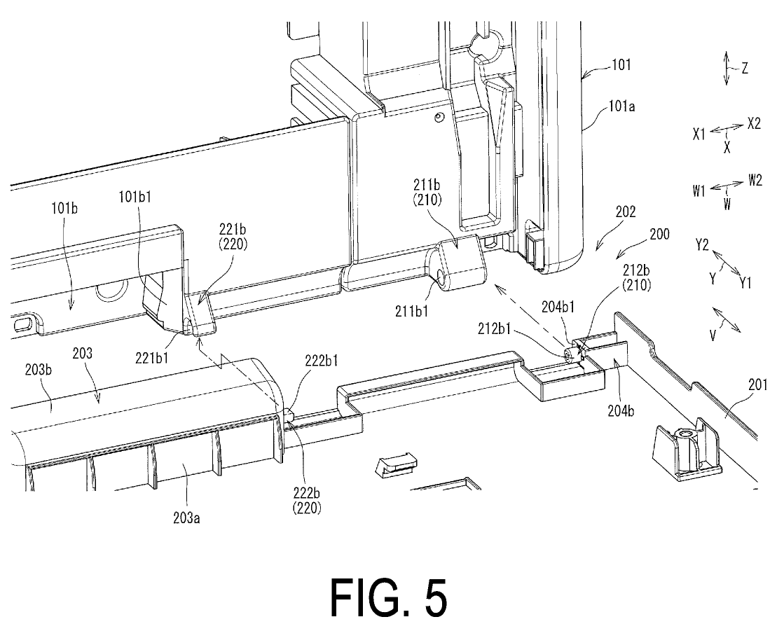

FIG. 4 is a perspective view of a state in which one cover-side first hinge portion 212a of a pair of cover-side first hinge portions 212a and 212b and one cover-side second hinge portion 222a of a pair of cover-side second hinge portions 222a and 222b are separated away from one main body-side first hinge portion 211a of a pair of main body-side first hinge portions 211a and 211b and one main body-side second hinge portion 221a of a pair of main body-side second hinge portions 221a and 221b, as viewed from obliquely above from the front side X1. FIG. 5 is a perspective view of a state in which the other cover-side first hinge portion 212b of the pair of cover-side first hinge portions 212a and 212b and the other cover-side second hinge portion 222b of the pair of cover-side second hinge portions 222a and 222b are separated away from the other main body-side first hinge portion 211b of the pair of main body-side first hinge portions 211a and 211b and the other main body-side second hinge portion 221b of the pair of main body-side second hinge portions 221a and 221b, as viewed from obliquely above from the front side X1.

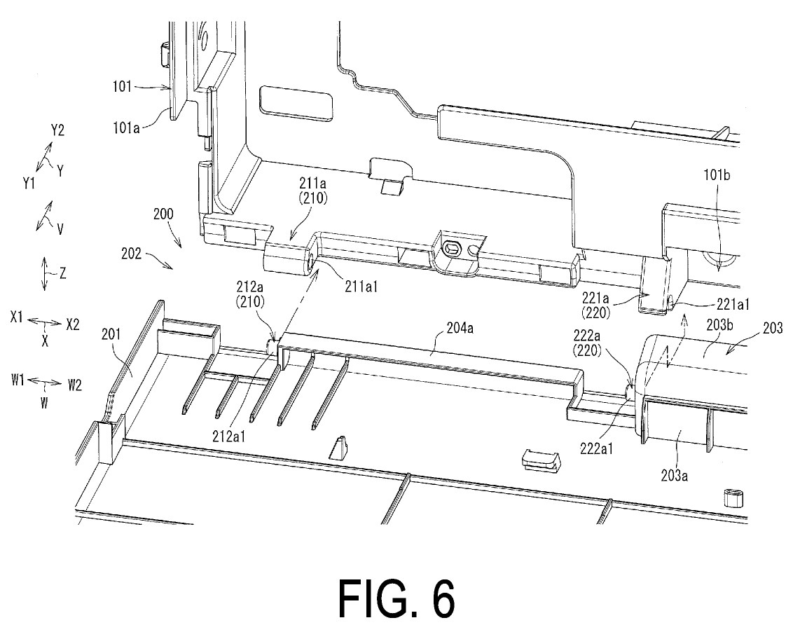

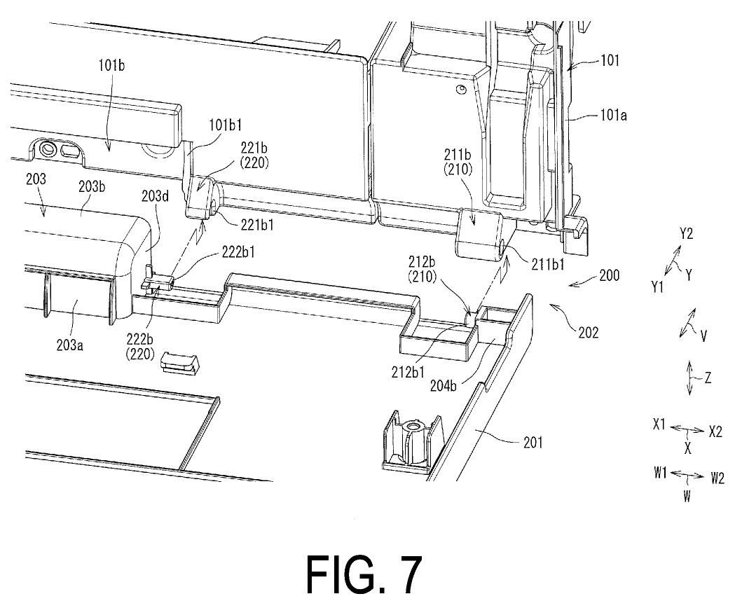

FIG. 6 is a perspective view of the state illustrated in FIG. 4, as viewed from obliquely above from the rear side X2. FIG. 7 is a perspective view of the state illustrated in FIG. 5, as viewed from obliquely above from the rear side X2.

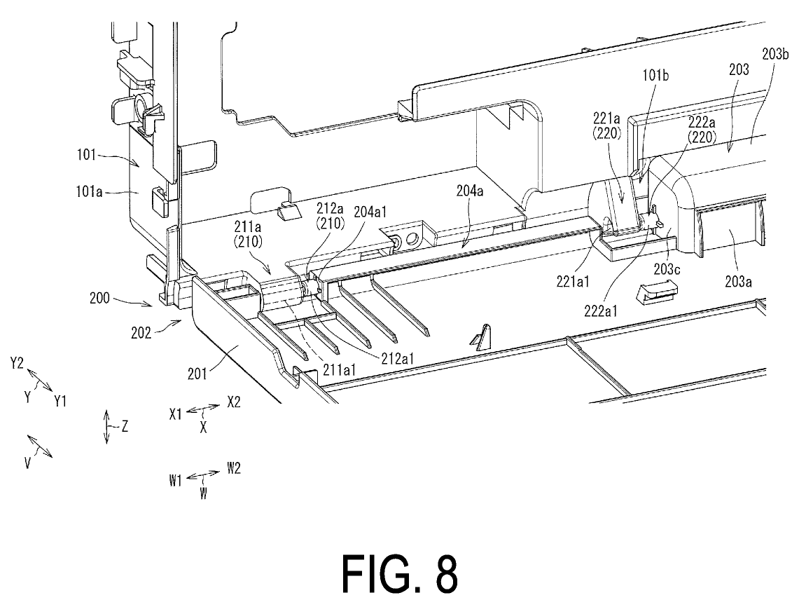

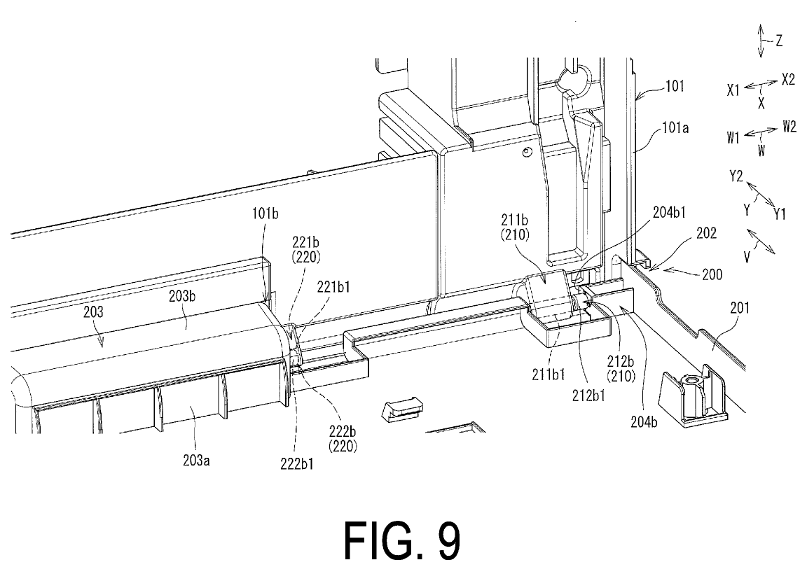

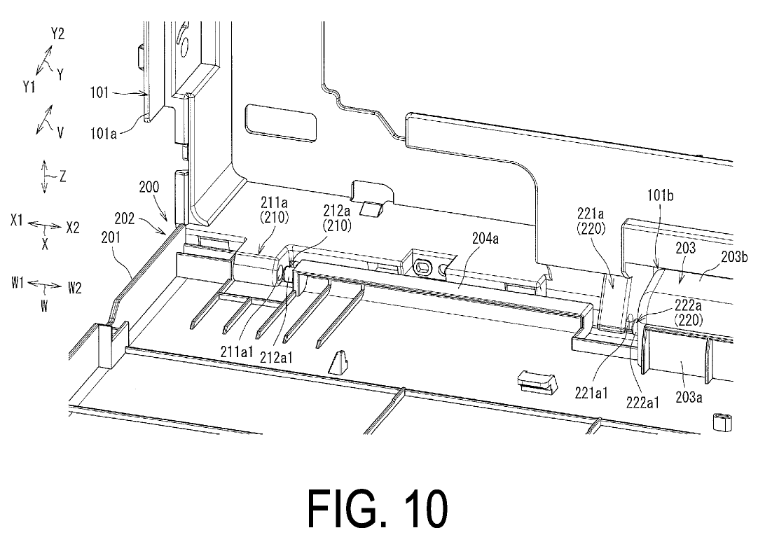

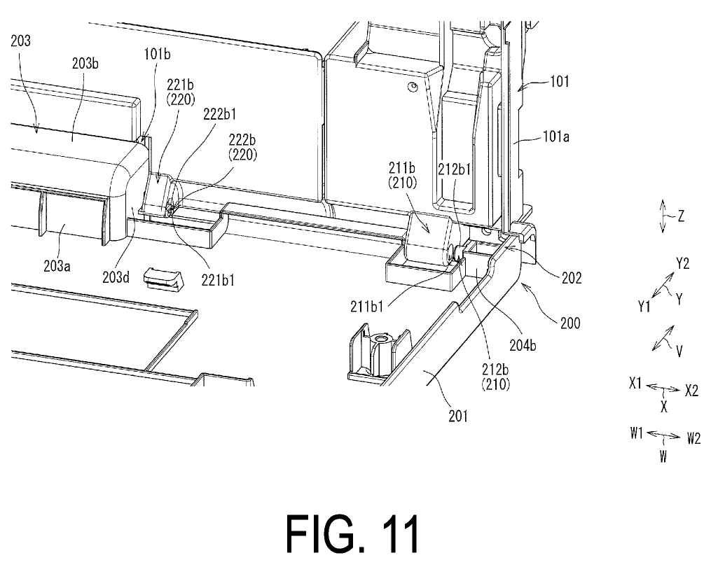

FIG. 8 is a perspective view of a state in which the one cover-side first hinge portion 212a and the one cover-side second hinge portion 222a are located at arrangement positions before being engaged with the one main body-side first hinge portion 211a and the one main body-side second hinge portion 221a, respectively, as viewed from obliquely above from the front side X1. FIG. 9 is a perspective view of a state after the other cover-side second hinge portion 222b is engaged with the other main body-side second hinge portion 221b and a state in which the other cover-side first hinge portion 212b is located at an arrangement position before being engaged with the other main body-side first hinge portion 211b, as viewed from obliquely above from the front side X1. FIG. 10 is a perspective view of the state illustrated in FIG. 8, as viewed from obliquely above from the rear side X2. FIG. 11 is a perspective view of the state illustrated in FIG. 9, as viewed from obliquely above from the rear side X2.

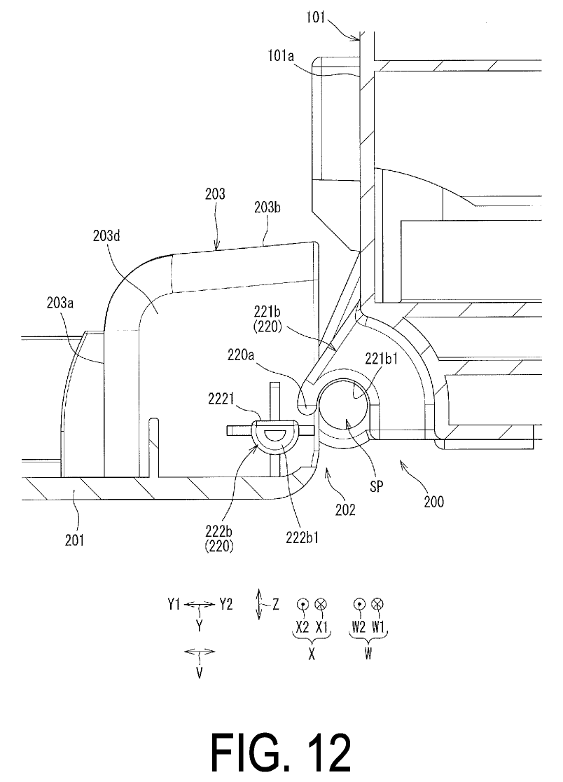

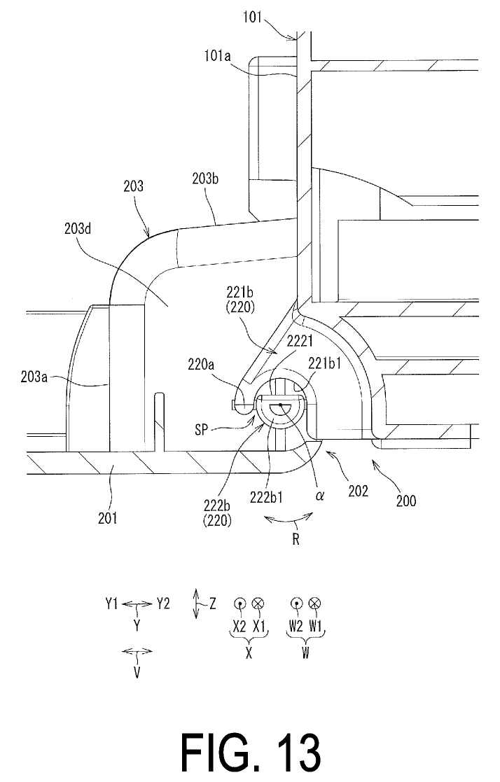

FIGS. 12 and FIG. 13 are cross-sectional views of states before and after engagement of the other main body-side second hinge portion 221b with the other cover-side second hinge portion 222b, respectively, as viewed from the rear side X2.

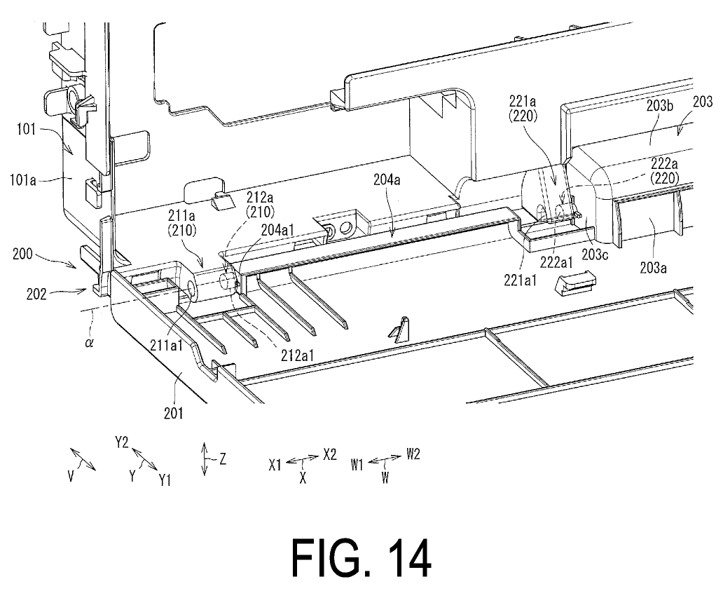

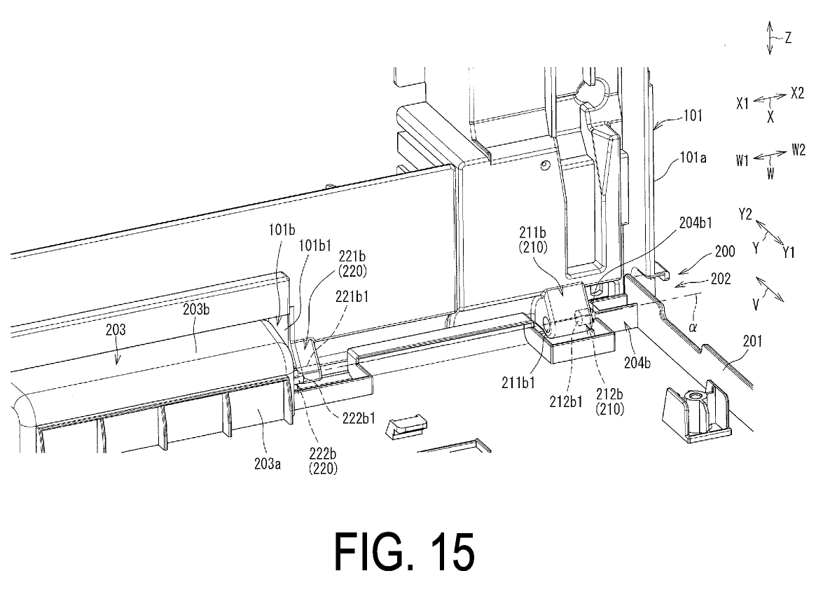

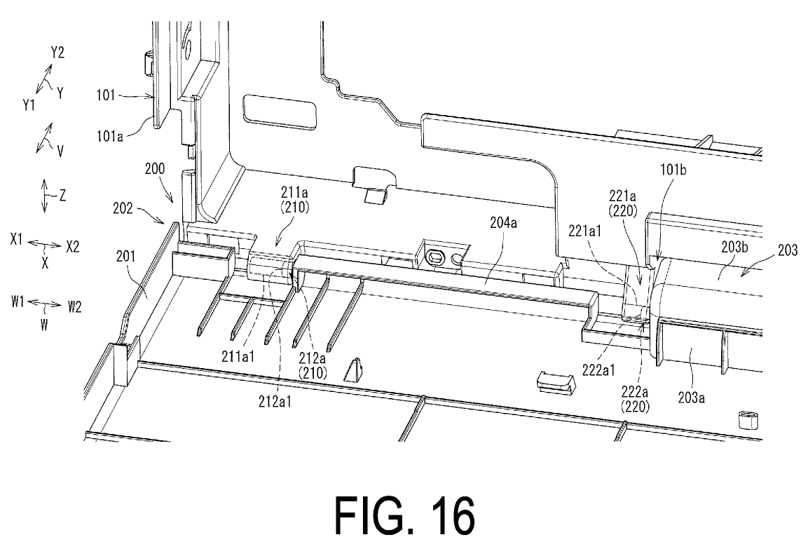

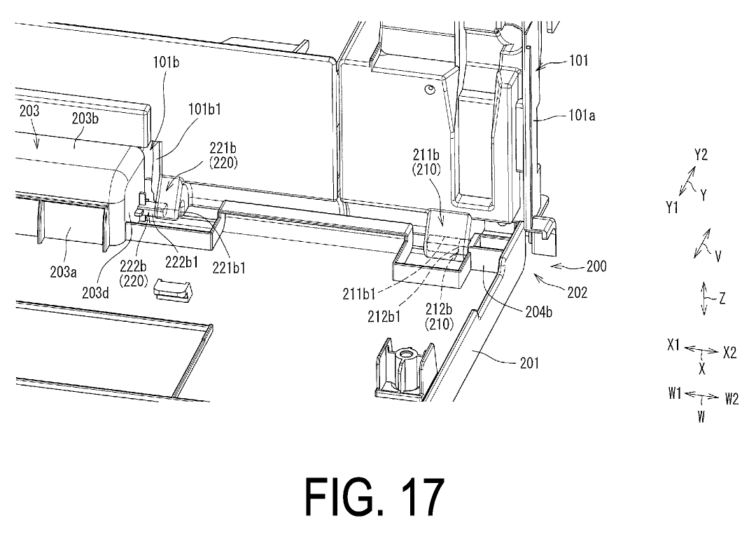

FIG. 14 is a perspective view of a state after the one cover-side first hinge portion 212a and the one cover-side second hinge portion 222a are engaged with the one main body-side first hinge portion 211a and the one main body-side second hinge portion 221a, respectively, as viewed from obliquely above from the front side X1. FIG. 15 is a perspective view of a state after the other cover-side first hinge portion 212b is engaged with the other main body-side first hinge portion 211b, as viewed from obliquely above from the front side X1. FIG. 16 is a perspective view of the state illustrated in FIG. 14, as viewed from obliquely above from the rear side X2. FIG. 17 is a perspective view of the state illustrated in FIG. 15, as viewed from obliquely above from the rear side X2.

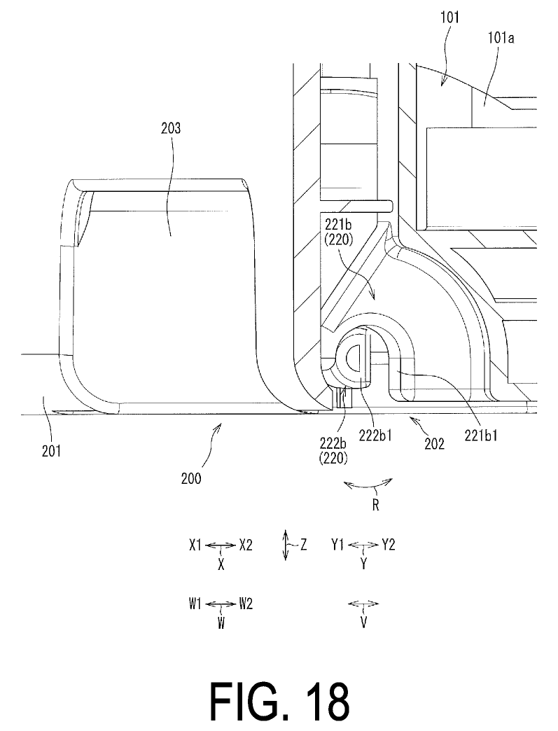

FIG. 18 is a perspective view of a cross section of a part corresponding to the other main body-side second hinge portion 221b and the other cover-side second hinge portion 222b in a state in which the opening/closing cover member 201 is closed, as viewed from the rear side X2.

### Present Embodiment

The image forming apparatus 100 includes a cover opening/closing structure 200. The cover opening/closing structure 200 includes the opening/closing cover member 201 and a hinge portion 202. The opening/closing cover member 201 covers a part (in this example, the right side surface 100c) of the image forming apparatus main body 101 (an example of a main body of an apparatus, specifically, a main body frame 101a). The hinge portion 202 opens and closes the opening/closing cover member 201 about a turning axis line α (see FIGS. 14 and FIG. 15) with respect to the image forming apparatus main body 101.

The opening/closing cover member 201 includes a grip portion 203 for lifting up the image forming apparatus main body 101. In this manner, it is possible to avoid an increase in assembly steps and cost caused by an increase in the number of components resulting from forming the grip portion 203 as a separate member.

The hinge portion 202 includes a first hinge portion 210 and a second hinge portion 220. The first hinge portion 210 turns the opening/closing cover member 201 about the turning axis line α on both sides (W1 and W2) of the grip portion 203 in a turning axis line direction W along the turning axis line α with respect to the image forming apparatus main body 101. The second hinge portion 220 turns the opening/closing cover member 201 about the turning axis line α by the grip portion 203 with respect to the image forming apparatus main body 101.

According to the present embodiment, the grip portion 203 is provided to the opening/closing cover member 201, and the opening/closing cover member 201 is not provided with an opening for allowing an operator to grip the grip portion 203. With this, inconveniences caused by the opening communicating with the internal space can be avoided (for example, inconveniences such as dust entering from the outside when the apparatus is the image forming apparatus 100, waste toner falling onto a floor through the opening).

Further, in addition to the first hinge portion 210, support can be achieved by the second hinge portion 220 that turns the opening/closing cover member 201 about the turning axis line α by the grip portion 203 with respect to the image forming apparatus main body 101. With this, when an operator grips the grip portion 203 to lift up the image forming apparatus 100 (an example of the apparatus), the grip portion 203 can be gripped stably. Thus, gripping stability of the grip portion 203 can be improved.

### First Embodiment

In the present embodiment, the grip portion 203 is provided at a lower end portion of the opening/closing cover member 201 in a state in which the opening/closing cover member 201 is closed and at a center portion thereof in the turning axis line direction α. Herein, as the center portion of the opening/closing cover member 201 to which the grip portion 203 is provided, a position within a region within ±10% of the overall length of the opening/closing cover member 201 in the turning axis line direction W, with reference to the center position of the grip portion 203 in the turning axis line direction W, can be exemplified.

In this configuration, the grip portion 203 is provided at the lower end portion of the opening/closing cover member 201 in a state in which the grip portion 203 is closed and at the center portion of the opening/closing cover member 201 in the turning axis line direction W. With this, an operator can easily lift up the image forming apparatus 100 by gripping the grip portion 203.

In detail, in a closed state, the opening/closing cover member 201 covers the image forming apparatus main body 101 down to the lower end. In this manner, a replacement component (for example, the powder collection container 115 extending to the lower end) that is provided to the entire image forming apparatus main body 101 can be replaced easily.

In this example, the grip portion 203 is formed to have a recess shape that is recessed into the image forming apparatus main body 101 so that the lower part thereof is open in a state in which the opening/closing cover member 201 is closed. In a state in which the opening/closing cover member 201 is closed, the grip portion 203 includes an upper surface portion 203a on the upper side, a first side surface portion 203b that extends downward from an end portion of the upper surface portion 203a on the image forming apparatus main body 101 side (inner side) in an intersection direction V (width direction) intersecting with (orthogonal to) both the turning axis line direction W and the up-down direction Z, and a pair of second side surface portions 203c and 203d that extend downward from end portions of the upper surface portion on both sides (W1 and W2) in the turning axis line direction W. The first side surface portion 203b is continuously coupled to the pair of second side surface portions 203c and 203d.

### Second Embodiment

In the present embodiment, the first hinge portion 210 includes the pair of cover-side first hinge portions 212a and 212b and the pair of main body-side first hinge portions 211a and 211b. The pair of cover-side first hinge portions 212a and 212b are provided to the opening/closing cover member 201 on both respective sides (W1 and W2) in the turning axis line direction W with the grip portion 203 interposed therebetween. The pair of main body-side first hinge portions 211a and 211b are provided to the image forming apparatus main body 101 so as to be engaged with the pair of cover-side first hinge portions 212a and 212b, respectively.

The second hinge portion 220 includes the pair of cover-side second hinge portions 222a and 222b and the pair of main body-side second hinge portions 221a and 221b. The pair of cover-side second hinge portions 222a and 222b are provided to the side surfaces (the pair of second side surface portions 203c and 203d) of the grip portion 203 on both sides (W1 and W2) in the turning axis line direction W, respectively. The pair of main body-side second hinge portions 221a and 221b are provided so as to be engaged with the pair of cover-side second hinge portions 222a and 222b, respectively, in the image forming apparatus main body 101.

In the present embodiment, when the pair of cover-side second hinge portions 222a and 222b and the pair of main body-side second hinge portions 221a and 221b are to be engaged with each other, the pair of cover-side first hinge portions 212a and 212b and the one cover-side second hinge portion 222a are arranged in advance at arrangement positions (see FIGS. 8 to FIG. 11) on the other side W2 in the turning axis line direction W (in the vicinity of the other side W2, specifically, in the vicinity of the rear side X2 in this example) with respect to the pair of main body-side first hinge portions 211a and 211b and the one main body-side second hinge portion 221a.

Herein, as the distance indicated by the expression “in the vicinity of the other side”, a distance that is close enough so that the cover-side first hinge portions 212a and 212b and the cover-side second hinge portion 222a are not engaged with the main body-side first hinge portions 211a and 211b and the main body-side second hinge portion 221a.

Incidentally, the other cover-side second hinge portion 222b of the pair of cover-side second hinge portions 222a and 222b protrudes to the other side W2 (the rear side X2 in this example) in the turning axis line direction W (see FIGS. 5 and FIG. 7), and hence the other cover-side second hinge portion 222b cannot be arranged on the other side W2 in the turning axis line direction W with respect to the other main body-side second hinge portion 221b (see FIGS. 9 and FIG. 11).

In this regard, in the present embodiment, the other cover-side second hinge portion 222b is engaged with the other main body-side second hinge portion 221b of the pair of main body-side second hinge portions 221a and 221b by moving the opening/closing cover member 201 in the intersection direction V intersecting with the turning axis line direction W (see FIGS. 9 and FIG. 11). In detail, one of the other main body-side second hinge portion 221b and the other cover-side second hinge portion 222b (the other main body-side second hinge portion 221b in this example) is formed into a shape in which a part (a part on the lower side) in a circumferential direction R about the turning axis line α (see FIGS. 13 and FIG. 18) is open.

Further, the pair of cover-side first hinge portions 212a and 212b and the one cover-side second hinge portion 222a of the pair of cover-side second hinge portions are engaged with the pair of main body-side first hinge portions 211a and 211b and the one main body-side second hinge portion 221a of the pair of main body-side second hinge portions 221a and 221b, respectively, by moving the opening/closing cover member 201 to the one side W1 (the front side X1 in this example) in the turning axis line direction W (see FIGS. 14 to FIG. 17). In detail, the pair of main body-side first hinge portions 211a and 211b or the pair of cover-side first hinge portions 212a and 212b (the pair of main body-side first hinge portions 211a and 211b in this example) is formed into a tubular shape about the turning axis line α.

In this configuration, first, the pair of cover-side first hinge portions 212a and 212b and the one cover-side second hinge portion 222a are moved in the intersection direction V, and are arranged on the other side W2 with respect to the pair of main body-side first hinge portions 211a and 211b and the one main body-side second hinge portion 221a. Similarly, the other cover-side second hinge portion 222b is moved in the intersection direction V. In this movement, when an open portion SP is formed in the other main body-side second hinge portion 221b (see FIGS. 12 and FIG. 13), the other cover-side second hinge portion 222b bypasses a distal end portion 220a of the other main body-side second hinge portion 221b, and is inserted into the open portion SP of the other main body-side second hinge portion 221b (see FIGS. 12 and FIG. 13). Further, although omitted in illustration, when the open portion SP is formed in the other cover-side second hinge portion 222b, the distal end portion of the other cover-side second hinge portion 222b bypasses the other main body-side second hinge portion 221b, and is inserted into the open portion of the other cover-side second hinge portion 222b. With this, the other cover-side second hinge portion 222b can be engaged with the other main body-side second hinge portion 221b. In this state, the pair of cover-side first hinge portions 212a and 212b and the one cover-side second hinge portion 222a are at the arrangement positions, and are not engaged with the pair of main body-side first hinge portions 211a and 211b and the one main body-side second hinge portion 221a, respectively.

Subsequently, the opening/closing cover member 201 is moved to the one side W1 in the turning axis line direction W, then the pair of cover-side first hinge portions 212a and 212b and the one cover-side second hinge portion 222a are moved from the arrangement positions to the one side W1 in the turning axis line direction W. With this, the pair of cover-side first hinge portions 212a and 212b and the one cover-side second hinge portion 222a can be engaged with the pair of main body-side first hinge portions 211a and 211b and the one main body-side second hinge portion 221a, respectively.

An aspect in which the pair of main body-side first hinge portions 211a and 211b and the pair of main body-side second hinge portions 221a and 221b include bearing portions or shaft portions can be exemplified. In other words, an aspect in which the pair of cover-side first hinge portions 212a and 212b and the pair of cover-side second hinge portions 222a and 222b include shaft portions or bearing portions can be exemplified.

In this example, the pair of cover-side first hinge portions 212a and 212b and the pair of cover-side second hinge portions 222a and 222b include first shaft portions 212a1 and 212b1 and second shaft portions 222a1 and 222b1, respectively, along the turning axis line direction W. The pair of main body-side first hinge portions 211a and 211b and the pair of main body-side second hinge portions 221a and 221b include first bearing portions 211a1 and 211b1 and second bearing portions 221a1 and 221b1 through which the first shaft portions 212a1 and 212b1 and the second shaft portions 222a1 and 222b1 are inserted, respectively. The pair of first bearing portions 211a1 and 211b1 and the pair of second bearing portions 221a1 and 221b1 on the main body side are provided to the image forming apparatus main body 101 so that the axis centers (the turning axis lines α) are located coaxially. Similarly, the pair of first shaft portions 212a1 and 212b1 and the pair of second shaft portions 222a1 and 222b1 on the cover side are provided to the opening/closing cover member 201 so that the axis centers (the turning axis lines α) are located coaxially.

In this example, the pair of main body-side first hinge portions 211a and 211b and the pair of main body-side second hinge portions 221a and 221b are provided to the main body frame 101a so as to protrude from the main body frame 101a to the opening/closing cover member 201 side in the intersection direction V.

The opening/closing cover member 201 includes a pair of support portions 204a and 204b. The first shaft portions 212a1 and 212b1 are provided to the pair of support portions 204a and 204b, respectively, so as to protrude from the pair of support portions 204a and 204b of the opening/closing cover member 201 to the one side W1 in the turning axis line direction W.

In detail, the pair of support portions 204a and 204b are provided along the turning axis line direction W so as to be aligned in the intersection direction V on both sides (W1 and W2) in the turning axis line direction W with the grip portion 203 of the opening/closing cover member 201 interposed therebetween. In a state in which the opening/closing cover member 201 is closed, the pair of support portions 204a and 204b are erected on the image forming apparatus main body 101 side.

End surfaces 204a1 and 204b1 along both the intersection direction V and the up-down direction Z are provided on the one side W1 of the pair of support portions 204a and 204b in the turning axis line direction W, respectively. The first shaft portions 212a1 and 212b1 are provided to the end surfaces 204a1 and 204b1, respectively, so as to protrude from the end surfaces 204a1 and 204b1 of the pair of support portions 204a and 204b to the one side W1 in the turning axis line direction W.

The pair of cover-side second hinge portions 222a and 222b are provided to the pair of second side surface portions 203c and 203d, respectively, so as to protrude from the pair of second side surface portions 203c and 203d of the grip portion 203 to both sides (W1 and W2) in the turning axis line direction W.

The pair of main body-side first hinge portions 211a and 211b are formed into a cylindrical shape. In this manner, the pair of main body-side first hinge portions 211a and 211b can be engaged securely with the pair of cover-side first hinge portions 212a and 212b over an entire turning operation of the opening/closing cover member 201.

Further, at least the other main body-side second hinge portion 221b of the pair of main body-side second hinge portions 221a and 221b (both portions in this example) is formed into an arc shape.

Note that the one main body-side second hinge portion 221a may be formed into a cylindrical shape. By forming at least the other main body-side second hinge portion 221b into an arc shape as described above, the other cover-side second hinge portion 222b can be easily engaged with and disengaged from the other main body-side second hinge portion 221b at a predetermined opening/closing position (preferably, an open position, more preferably, a fully open position) of the opening/closing cover member 201 when the opening/closing cover member 201 is moved in the intersection direction V.

### Third Embodiment

In the present embodiment, the other cover-side second hinge portion 222b includes the second shaft portion 222b1, and the other main body-side second hinge portion 221b includes the second bearing portion 222b1 through which the other second shaft portion 222b1 is inserted. In this case, the other second shaft portion 222b1 is preferably formed into a shape in which a part in the circumferential direction R is cut out, and the other second bearing portion 222b1 is preferably formed into a shape in which a part on the lower side in the circumferential direction R is open.

In this manner, the other cover-side second hinge portion 222b can be easily engaged with and disengaged from the other main body-side second hinge portion 221b at the predetermined opening/closing position of the opening/closing cover member 201 when the opening/closing cover member 201 is moved in the intersection direction V. Further, in a state in which the other second shaft portion 222b1 and the other second bearing portion 222b1 are engaged with each other and a state in which the opening/closing cover member 201 is closed (see FIG. 18), when an operator grips the grip portion 203 to lift up the image forming apparatus 100, the grip portion 203 can be gripped securely and stably. Thus, gripping stability of the grip portion 203 can be improved.

### Fourth Embodiment

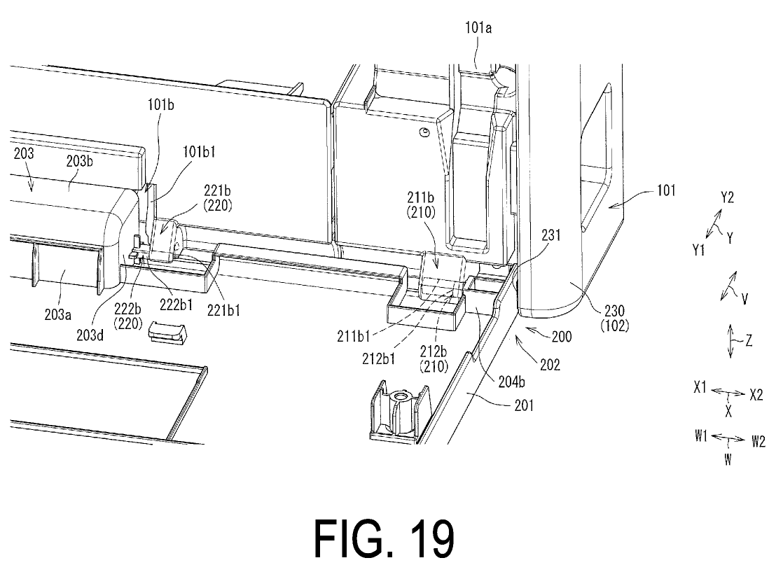

In the present embodiment, the other second shaft portion 222b1 is formed to have a D-like cross section (see FIGS. 13 and FIG. 19) in which a part in the circumferential direction R is a plane surface 2221 (see FIGS. 12 and FIG. 13). The other second bearing portion 222b1 is formed to have an arc-like cross section in which a part on the lower side in the circumferential direction R is open (see FIGS. 13 and FIG. 19).

In this configuration, a configuration in which the other second shaft portion 222b1 is easily engaged with and disengaged from the other second bearing portion 221b1 at the predetermined opening/closing position (for example, the fully open position) of the opening/closing cover member 201 can be achieved.

### Fifth Embodiment

In the present embodiment, the plane surface 2221 of the other second shaft portion 222b1 is located at an upper part in a state in which the opening/closing cover member 201 is fully opened.

In this configuration, a configuration in which the other second shaft portion 222b1 is easily engaged with and disengaged from the other second bearing portion 221b1 at the fully open position of the opening/closing cover member 201 can be achieved. Herein, as the fully open position, a horizontal position or a substantially horizontal position can be exemplified. As the substantially horizontal position, a position within about ±10 degrees with reference to the horizontal position can be exemplified.

### Sixth Embodiment

In the present embodiment, the image forming apparatus main body 101 is provided with a receiving recess portion 101b. When the opening/closing cover member 201 is closed, the receiving recess portion 101b receives the grip portion 203 of the opening/closing cover member 201.

Incidentally, before moving the opening/closing cover member 201 to the one side W1 in the turning axis line direction W, when the pair of cover-side first hinge portions 212a and 212b and the one cover-side second hinge portion 222a are arranged in advance at the arrangement positions (see FIGS. 8 to FIG. 11), the grip portion 203 of the opening/closing cover member 201 may interfere with the receiving recess portion 101b of the image forming apparatus main body 101.

In this regard, the receiving recess portion 101b includes a recessed portion 101b1 (see FIGS. 5 and FIG. 7). The recessed portion 101b1 is configured to be recessed so as to prevent interference of the grip portion 203 of the opening/closing cover member 201 when the pair of cover-side first hinge portions 212a and 212b and the one cover-side second hinge portion 222a are arranged in advance at the arrangement positions on the other side W2 in the turning axis line direction W with respect to the pair of main body-side first hinge portions 211a and 211b and the one main body-side second hinge portion 221a before moving the opening/closing cover member 201 to the one side W1 in the turning axis line direction W. In this example, the recessed portion 101b1 is provided at the end portion of the receiving recess portion 101b on the other side W2 in the turning axis line direction W.

In this configuration, the receiving recess portion 101b includes the recessed portion 101b1. Thus, even when the pair of cover-side first hinge portions 212a and 212b and the one cover-side second hinge portion 222a are arranged in advance at the arrangement positions, interference of the grip portion 203 of the opening/closing cover member 201 with the receiving recess portion 101b of the image forming apparatus main body 101 can be avoided securely.

### Seventh Embodiment

In the present embodiment, the recessed portion 101b1 is formed as an inclination portion that is inclined so as to approach the opening/closing cover member 201 as proceeding from the one side W1 to the other side W2 in the turning axis line direction W.

In this configuration, a configuration in which the grip portion 203 of the opening/closing cover member 201 is recessed so as not to interfere can be easily achieved.

### Eighth Embodiment

FIG. 19 is a perspective view illustrating a regulating member 230 that is attached to the image forming apparatus main body 101 in the state illustrated in FIG. 17.

Incidentally, when the opening/closing cover member 201 is moved to the other side W2 in the turning axis line direction W, the opening/closing cover member 201 may come off from the image forming apparatus main body 101. In particular, in a state in which the opening/closing cover member 201 is closed, the image forming apparatus 100 can be operated. However, when the opening/closing cover member 201 comes off from the image forming apparatus main body 101, the image forming apparatus 100 cannot be operated properly.

In this regard, in the present embodiment, the cover opening/closing structure 200 further includes the regulating member 230. The regulating member 230 regulates movement of the opening/closing cover member 201 to the other side W2 in the turning axis line direction W.

In this configuration, the regulating member 230 can regulate movement of the opening/closing cover member 201 to the other side W2 in the turning axis line direction W, and can effectively prevent the opening/closing cover member 201 from coming off from the image forming apparatus main body 101. In particular, in a state in which the opening/closing cover member 201 is closed, the image forming apparatus 100 can be operated. The opening/closing cover member 201 can be prevented from coming off from the image forming apparatus main body 101, and hence the image forming apparatus 100 can be operated properly.

In this example, the regulating member 230 is a cover member 102 that is provided adjacent to the opening/closing cover member 201 to cover a part of the image forming apparatus main body 101 (the rear surface 100b in this example). In other words, the cover member 102 also serves as the regulating member 230. The cover member 102 is attached and fixed to the image forming apparatus main body 101. The regulating member 230 includes a regulating portion 231, and the regulating portion 231 functions as described above. With this, the opening/closing cover member 201 can be regulated at a correspondingly low cost without separately providing a regulating member.

The disclosure is not limited to the embodiments described above and can be embodied in other specific forms. The present embodiments are therefore to be considered in all respects as illustrative and not restrictive. The scope of the present disclosure is indicated by the claims, and is not restricted by the description in the specification. Furthermore, all modifications and alterations falling within the equivalent scope of the claims are included within the scope of the present disclosure.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A cover opening/closing structure comprising:
an opening/closing cover member that covers a main body of an apparatus; and
a hinge portion that opens and closes the opening/closing cover member about a turning axis line with respect to the main body, wherein
the opening/closing cover member includes a grip portion for lifting up the apparatus, and
the hinge portion includes:
a first hinge portion that turns the opening/closing cover member about a turning axis line on both sides of the grip portion in a turning axis line direction along the turning axis line with respect to the main body; and
a second hinge portion that abuts the grip portion and turns the opening/closing cover member about the turning axis line at a position nearer the grip portion than the first hinge portion with respect to the main body.

2. The cover opening/closing structure according to claim 1, wherein
the grip portion is provided at a lower end portion of the opening/closing cover member in a state in which the opening/closing cover member is closed and at a center portion thereof in the turning axis line direction.

3. The cover opening/closing structure according to claim 1, wherein
the first hinge portion includes:
a pair of cover-side first hinge portions that are provided to the opening/closing cover member on both respective sides in the turning axis line direction with the grip portion interposed therebetween; and
a pair of main body-side first hinge portions that are provided to the main body so as to be engaged with the pair of cover-side first hinge portions, respectively,
the second hinge portion includes:
a pair of cover-side second hinge portions that are provided to respective side surfaces on both sides of the grip portion in the turning axis line direction; and
a pair of main body-side second hinge portions that are provided to the main body so as to be engaged with the pair of cover-side second hinge portions, respectively,
the pair of cover-side first hinge portions and one cover-side second hinge portion of the pair of cover-side second hinge portions are engaged with the pair of main body-side first hinge portions and one main body-side second hinge portion of the pair of main body-side second hinge portions, respectively, by moving the opening/closing cover member to one side in the turning axis line direction, and
the other cover-side second hinge portion of the pair of cover-side second hinge portions is engaged with the other main body-side second hinge portion of the pair of main body-side second hinge portions by moving the opening/closing cover member in an intersection direction intersecting with the turning axis line direction.

4. The cover opening/closing structure according to claim 3, wherein
the other cover-side second hinge portion includes a second shaft portion along the turning axis line direction, and the other main body-side second hinge portion includes a second bearing portion through which the other second shaft portion is inserted, and
the other second shaft portion is formed into a shape in which a part in a circumferential direction about the turning axis line is cut out, and the other second bearing portion is formed into a shape in which a part on a lower side in the circumferential direction is open.

5. The cover opening/closing structure according to claim 3, wherein
the other cover-side second hinge portion includes a second shaft portion along the turning axis line direction, and the other main body-side second hinge portion includes a second bearing portion through which the other second shaft portion is inserted, and
the other second shaft portion is formed to have a D-like cross section in which a part in a circumferential direction about the turning axis line is a plane surface, and the other second bearing portion is formed to have an arc-like cross section in which a part on a lower side in the circumferential direction is open.

6. The cover opening/closing structure according to claim 5, wherein
the plane surface of the other second shaft portion is located at an upper part in a state in which the opening/closing cover member is fully opened.

7. The cover opening/closing structure according to claim 3, wherein
the main body is provided with a receiving recess portion that receives the grip portion of the opening/closing cover member when the opening/closing cover member is closed, and
the receiving recess portion includes a recessed portion that is recessed so as to prevent interference of the grip portion of the opening/closing cover member when the pair of cover-side first hinge portions and the one cover-side second hinge portion are arranged in advance at arrangement positions on the other side in the turning axis line direction with respect to the pair of main body-side first hinge portions and the one main body-side second hinge portion before moving the opening/closing cover member to the one side in the turning axis line direction.

8. The cover opening/closing structure according to claim 7, wherein
the recessed portion is formed as an inclination portion that is inclined so as to approach the opening/closing cover member as proceeding from the one side to the other side in the turning axis line direction.

9. The cover opening/closing structure according to claim 3, further comprising:
a regulating member that regulates movement of the opening/closing cover member to the other side in the turning axis line direction.

10. An image forming apparatus, comprising:
a cover opening/closing structure according to claim 1.
